(19) United States
(12) Patent Application Publication
(10) Pub. No.: US 2012/0006149 A1
(43) Pub. Date: Jan. 12, 2012

(54) Pedal Assembly

(75) Inventor: Alexander Galea, Dingli (MT)

(73) Assignee: METHODE ELECTRONICS MALTA LTD., Mriehel (MT)

(21) Appl. No.: 13/179,544

(22) Filed: Jul. 10, 2011

(30) Foreign Application Priority Data
Jul. 12, 2010 (DE) 102010026956.5

(51) Int. Cl. G05G 1/327

(52) U.S. Cl. 74/560

(57) ABSTRACT

A pedal assembly for use in a motor vehicle includes a pedal member partially mounted in a housing and configured to rotate about a fulcrum. At least one pressure-exerting spring biases the pedal member to an initial position. The pedal member is pivotable about the fulcrum against a force of the at least one pressure-exerting spring. A spring member is disposed inside the housing. One end of the spring member is fixedly fastened to the housing and an opposite end of the spring member is moveably mounted to the housing. The pedal member has a slide member which when the pedal member is actuated slides on and along one side of the spring member and exerts pressure on the one side of the spring member.

### CROSS-REFERENCE TO RELATED APPLICATIONS

This application claims the benefit of German Patent Application No. DE 10 2010 026 956.5 filed Jul. 12, 2010 entitled “Pedal Assembly” which is hereby incorporated by reference herein in its entirety.

### BACKGROUND OF THE INVENTION

The present invention relates to a pedal assembly.

German Utility Model DE 10 2007 018 962 A1 discloses a clutch pedal for a motor vehicle which comprises a position sensor providing signals as a basis for electronically controlling a clutch included in the drive train of the vehicle, the clutch being actuated correspondingly by an actuator powered by an auxiliary energy source. Spring elements engaging the clutch pedal are provided to generate a pedal force-displacement characteristic which describes a driver-sensible pedal force along the pedal path so that the pedal force characteristic—starting from the neutral position of the pedal—shows an actuating force increasing continuously to a maximum and then continuing by a digressive profile. In addition to a pressure-exerting spring moving the clutch pedal to its neutral position, an over center spring is provided for generating said pedal force characteristic.

German Utility Model DE 103 15 589 B4 discloses a spring for use in a pedal assembly, the pedal comprising a base plate and a pedal arm as well as an axis about which the pedal arm may pivot relative to the base plate. A spring is provided between the base plate and the pedal arm. One end of the spring is connected fixedly to the base plate; the other end of the spring slidingly abuts on the pedal arm. The spring itself consists of a fiber composite component comprising a reinforcing material and an encasing composite material. Several layers, which are introduced individually in the manufacturing process, are firmly connected with each other at one end of the spring and loosely placed on top of each other at its opposite end. The stiffness of each layer is obtained by the thickness of the material, the type of material used and the orientation of the reinforcing fibers.

### BRIEF SUMMARY OF THE INVENTION

In one embodiment there is a pedal assembly for use in a motor vehicle, the pedal assembly comprising: a pedal member partially mounted in a housing and configured to rotate about a fulcrum; at least one pressure-exerting spring biasing the pedal member to an initial position, the pedal member being pivotable about the fulcrum against a force of the at least one pressure-exerting spring; and a spring member disposed inside the housing, one end of the spring member being fixedly fastened to the housing and an opposite end of the spring member being moveably mounted to the housing, the pedal member having a slide member which when the pedal member is actuated slides on and along one side of the spring member and exerts pressure on the one side of the spring member. In one embodiment, the spring member is a leaf spring. In one embodiment, the leaf spring is comprised of a metal material. In one embodiment, when the slide member moves as the pedal member is pivoted about the fulcrum, the spring member exerts a counter-force against the slide member and undergoes resilient deformation at the same time. In one embodiment, the counter-force generated by the spring member and directed against the slide member under the relative movement between the slide member and the spring member contributes to an automatic pivoting of the pedal member towards the initial position.

In one embodiment, the opposite end of the spring member abuts a supporting portion of the housing. In one embodiment, the slide member is comprised of a plastic material. In one embodiment, the pedal member includes an abutment portion configured to engage an area of housing in a final position. In one embodiment, the at least one pressure-exerting spring includes a compression spring having one end supported on the pedal member and an opposite end supported on the housing. In one embodiment, the spring member is disposed on a side opposite a foot plate of the pedal member relative to the fulcrum. In one embodiment, the at least one pressure-exerting spring is disposed on the side opposite foot plate of pedal member relative to fulcrum.

In one embodiment, as the pedal member rotates from the initial position about the fulcrum and returns towards the initial position by rotating about the fulcrum, the pressure-exerting spring and the spring member co-operate by generating different force gradients. In one embodiment, the spring member biases the pedal member toward the initial position and wherein a rate of change in biasing force during movement of the pedal member is greater proximate the initial position and a final position than a central position between the initial and final positions. In one embodiment, the spring member biases the pedal member toward the initial position and wherein a biasing force during a forward stroke of the pedal member is greater than a biasing force during a return stroke of the pedal member.

In another embodiment, there is a pedal assembly comprising: a pedal member configured to rotate about a fulcrum from an initial position to a first position, from the first position to a second position and from the second position to a final position, the pedal moving a first distance between the initial position and the first position, a second distance between the first position and the second position and a third distance between the second position and the third position; and a purely mechanical biasing system coupled to the pedal member and configured to bias the pedal member from the final position to the second position, from the second position to the first position and from the first position to the initial position, wherein a first increase in biasing force between the initial position and the first position over the first distance and a third increase in biasing force between the second position and the final position over the third distance are each greater than a second increase in biasing force between the first position and the final position over the second distance. In a further embodiment, the pedal assembly comprises a housing, and wherein the pedal member has a biasing end disposed within the housing and a pedal end disposed outside of the housing, the pedal member configured to rotate about the fulcrum between the biasing end and the pedal end, the biasing assembly being coupled to the biasing end.

In one embodiment, the biasing system includes a spring member, one end of the spring member being fixedly fastened to the housing and an opposite end of the spring member being moveably mounted to the housing, the pedal member having a slide member which when the pedal member is actuated slides on and along one side of the spring member and exerts pressure on the one side of the spring member. In one embodiment, the biasing system includes at least one compression spring. In one embodiment, the biasing system includes a leaf spring. In one embodiment, a biasing force during a forward stroke of the pedal member is greater than a biasing force during a return stroke of the pedal member.

In another embodiment, there is a pedal assembly comprising: a pedal member configured to rotate about a fulcrum between an initial position to a final position; and a purely mechanical biasing system coupled to the pedal member and configured to bias the pedal member from the final position to the initial position, a biasing force during a forward stroke of the pedal member from the initial position to the final position being greater than a biasing force during the return stroke of the pedal member from the final position to the initial position. In one embodiment, the biasing system includes a leaf spring.

### BRIEF DESCRIPTION OF THE SEVERAL VIEWS OF THE DRAWINGS

The foregoing summary, as well as the following detailed description of embodiments of the pedal assembly, will be better understood when read in conjunction with the appended drawings of an exemplary embodiment. It should be understood, however, that the invention is not limited to the precise arrangements and instrumentalities shown.

In the drawings:

FIG. 1 is a side cross sectional view of a pedal assembly in accordance with an exemplary embodiment of the present invention;

FIG. 2 is an enlarged view of a spring assembly in the pedal assembly shown in FIG. 1; and

FIG. 3 is a graph illustrating the force which the spring assembly of the present pedal assembly generates by the pedal member being actuated.

### DETAILED DESCRIPTION OF THE INVENTION

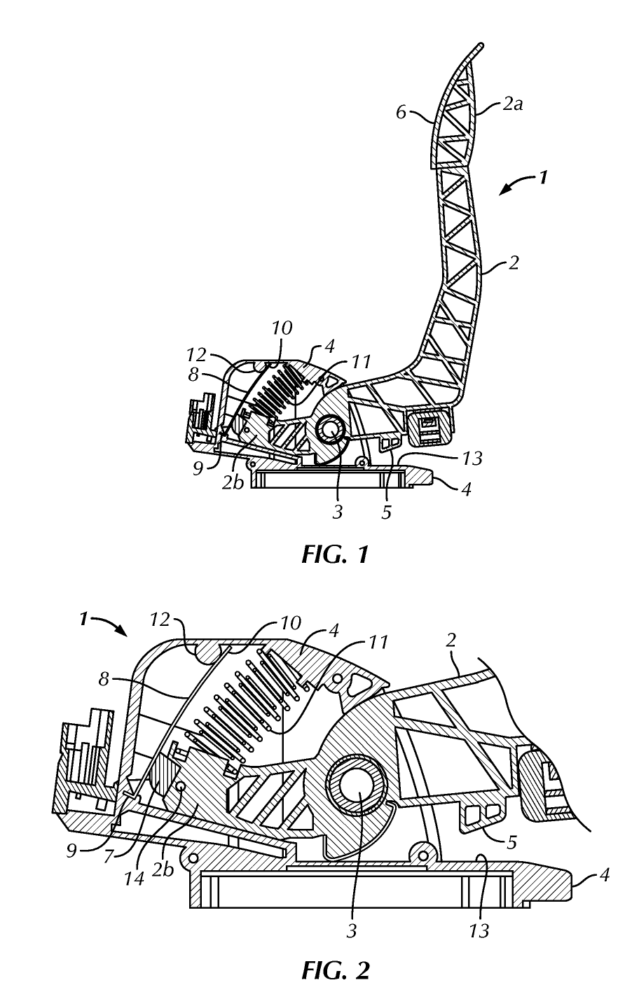

Referring to the drawings in detail, wherein like reference numerals indicate like elements throughout, there is shown in FIGS. 1 and 2 a pedal assembly, generally designated 1, in accordance with an exemplary embodiment of the present invention.

Pedal assembly 1 is used to control the operation of a device. In some embodiments, pedal assembly 1 controls a vehicle. In one embodiment, pedal assembly 1 is configured to be operated by a user's foot. In one embodiment, pedal assembly 1 controls the accelerator of a vehicle. In some embodiments, pedal assembly 1 includes an electric sub-system (not shown) which detects the movement of a pedal member 2 and processes this information to generate a signal indicative of the movement of pedal member 2 for use as input to, for example, a vehicle control system.

In some embodiments, pedal assembly 1 conveys to the user a reproducible and reliable haptic sensation of the amount to which the pedal assembly is actuated. In some embodiments, pedal assembly 1 includes a purely mechanical biasing assembly. In some embodiments, the biasing assembly generates a reproducible haptic feeling for the movement of pedal member 2 which is reliably sensible to the user. In one embodiment, redundancy is preferably provided for the automatic return function of pedal member 2.

Referring to FIGS. 1 and 2, in one embodiment, pedal assembly 1 includes a pedal member 2 mounted for rotation about a fulcrum 3. Pedal member 2 includes a pedal end 2a and a biasing end 2b. In one embodiment, pedal assembly 1 includes a biasing assembly for biasing pedal assembly toward an initial position (the position shown in FIGS. 1 and 2). In one embodiment, fulcrum 3 is positioned between pedal end 2a and biasing end 2b. In an alternative embodiment, pedal end 2a and biasing end 2b are on the same side relative to fulcrum 3. In one embodiment, pedal end 2a includes a foot plate 6 against which a vehicle driver will press his/her foot to actuate or pivot pedal member 2 about fulcrum 3. In one embodiment, biasing end 2b is coupled to the biasing assembly. In some embodiments, the biasing assembly is contained at least partially within a housing 4. In one embodiment, the biasing assembly is completely contained within housing 4.

In one embodiment, the biasing assembly includes at least one biasing member. In one embodiment, the at least one biasing member includes one or more pressure-exerting springs 11. In one embodiment, one or more pressure-exerting springs 11 include a helical compression spring. In one embodiment, one or more pressure-exerting springs 11 is coupled between biasing end 2b and a surface coupled to fulcrum 3. In one embodiment, one or more pressure-exerting springs 11 is coupled between biasing end 2b and housing 4. In one embodiment, housing 4 is coupled to fulcrum 3.

In one embodiment, the at least one biasing member includes a spring member 8. In one embodiment, spring member 8 includes a leaf spring. In one embodiment, spring member 8 is comprised of metal such as stainless steel. In one embodiment, spring member 8 is comprised of a metal having strong anti-corrosion properties. In one embodiment, spring member 8 includes one or more biasing members of any type configured to allow for the force profiles as described further below.

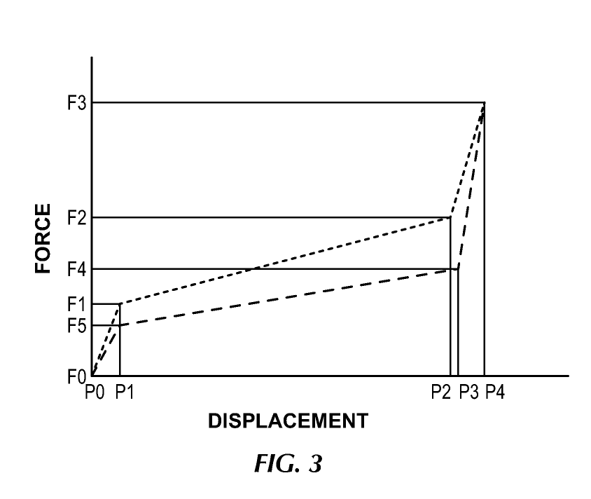

Referring to FIG. 2, in one embodiment, pedal member 2 has an abutment portion 5. In one embodiment, abutment portion 5 is configured to engage a contact area 13 of housing 4 when pedal member 2 has been actuated to full stroke or a final position P4, starting from initial position P0 (see FIG. 3). In one embodiment, abutment portion 5 is positioned between pedal end 2a and fulcrum 3. In alternative embodiments, abutment portion 5 is position between biasing end 2b and fulcrum 3.

Referring to FIGS. 2 and 3, in one embodiment, pedal member 2 engages spring member 8 to control the biasing force and affect the force profile the user exerts on the foot plate 6. In one embodiment, pedal member 2 includes a slide member 7 for engaging spring member 8. In one embodiment, slide member 7 is disposed proximate biasing end 2b. In one embodiment, slide member 7 is disposed between biasing end 2b and fulcrum 3. In an alternative embodiment, slide member 7 is disposed between pedal end 2a and fulcrum 3. In one embodiment, slide member 7 is comprised of a material different than pedal member 2. In one embodiment, slide member 7 is comprised of a plastic or polymeric material. In one embodiment, pedal member 2 is comprised of a stronger material than the slide member 7 such as metal. In one embodiment, slide member 7 is fastened to pedal member 2 by, for example, a fastener 14. In one embodiment, slide member 7 is snap or friction fit to pedal member 2. In one embodiment, slide member 7 is integral with pedal member 2.

Referring to FIG. 2, spring member 8 includes a first end 9 and a second end 10. In one embodiment, first end 9 is fixedly attached to housing 4. In one embodiment, second end 10 is slideably coupled to housing 4. In one embodiment, second end 10 abuts a supporting portion 12. In one embodiment, supporting portion 12 includes a projection extending from housing 4. In alternative embodiments, supporting portion 12 includes additional projections and/or grooves in the housing 4. In one embodiment, allowing second end 10 to move relative to housing 4 allows for the desired resilient movement or bending of spring member 8.

In one embodiment, as pedal member 2 is actuated by the user by for example, pressing their foot on foot plate 6, biasing end 2b is pivoted upwards about fulcrum 3. In one embodiment, as baising end 2b is moved, slide member 7 slides along spring member 8. In one embodiment, spring member 8 delivers a resistant or biasing force to biasing end 2b. In one embodiment, spring member 8 deliver a resistant or biasing force to biasing end 2b in addition to the biasing force from one or more pressure-exerting springs 11. In one embodiment, the biasing force from spring member 8 conveys to the driver or user actuating pedal member 2 a reproducible haptic sensation such that the user can determine the position of pedal member 2 relative to fulcrum 3.

Referring to FIG. 3, which illustrates the movement of pedal member 2 along the X-axis and the force generated by this movement along the Y-axis, in one embodiment, the biasing force generated by the biasing assembly is configured to provide a desired haptic sensation in order to feel where pedal member 2 is positioned relative to fulcrum 3. In one embodiment, spring member 8 biases the pedal member toward the initial position and a rate of change in biasing force during movement of the pedal member is greater proximate the initial position P0 to P1 and a final position P2 to P4 or P4 to P3 than a central position P1 to P2 or P3-P1. In one embodiment, spring member 8 biases pedal member 2 toward the initial position and a biasing force during a forward stroke of the pedal member (see top force profile line in FIG. 3) is greater than a biasing force during a return stroke of the pedal member (see bottom force profile line in FIG. 3). For example, the change in force to actuate pedal member 2 may increase at a faster rate near the beginning and end of pedal travel. In one embodiment, a first increase in biasing force (F1-F0) over a first distance (P1-P0) and a third increase in biasing force (P4-P3) over a third distance (P4-P2) are each greater than a second increase in biasing force (F2-F1) over a second distance (P2-P1).

In one embodiment, in order to convey to the user a true haptic sensation, it may be desirable to also generate different force gradients during the forward and backward strokes of pedal member 2 to as illustrated in the diagram of FIG. 3. In one embodiment, the forward stroke upon depression of pedal member 2 may have higher forces (top line in FIG. 3) than the backward stroke of pedal member 2 (bottom line in FIG. 3). In one embodiment, a force hysteresis (see e.g., F2-F4 and F1-F5) is provided.

In one embodiment, the force gradients shown in FIG. 3 are generated by the combination of at least one pressure-exerting spring 11 and the varying frictional and/or pressure force resulting from the relative movement between slide member 7 and spring member 8. In one embodiment, the force component resulting from the reaction between slide member 7 and spring member 8 contributes to an automatic return function of pedal member 2, which is important if pressure-exerting spring 11 fails.

In one embodiment, as pedal member 2 is depressed, the frictional force component and the reactive force component acting vertically thereto, which results from slide member 7 cooperating with spring member 8, contribute to an increase of the force to be exerted on foot plate 6. In one embodiment, releasing pedal member 2 causes the frictional force component to reverse its direction which, due to the configuration of spring member 8, may reduce the magnitude of the force acting on foot plate 6. For example, the angle of spring member 8 relative to slide member 7 may allow for a decrease in biasing force on the return stroke. In one embodiment, the surface texture of spring member 8 and/or slide member 7 may be configured to also or alternatively control the difference in forces between the forward and backward strokes. In one embodiment, spring member 8 and slide member 7 are configured to provide a controllable and predictable force displacement curve.

In some embodiments, advantages of the above embodiments may reside in the sliding engagement of slide member 7 made of a plastic material on a leaf spring member 8 made of metal results in the friction causing a hysteresis function of the characteristic resulting from the depression of pedal member 2. In the case of leaf spring components 8 consisting of metal, in some embodiments, mathematical models may be more easily set up that will produce more accurate results and greatly simplify the manufacturing process.

In some embodiments, another advantage may be that the surface of the spring member changes very little even after a great number of actuations so that the operating characteristics of the pedal assembly do not vary over the entire useful life of the pedal assembly. In some embodiments, the frictional heat generated by the actuation of the spring member is effectively dispersed. In some embodiments, the metal sliding surface of the spring member will not be adversely affected by the frictional heat caused by the slide member sliding on it.

It will be appreciated by those skilled in the art that changes could be made to the exemplary embodiments shown and described above without departing from the broad inventive concept thereof It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. The words “right”, “left”, “lower” and “upward” designate directions in the drawings to which reference is made. The words “inwardly” and “outwardly” refer to directions toward and away from, respectively, the geometric center of the pedal assembly or other referenced feature. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

### REFERENCE CHARACTERS

1 pedal assembly

2 pedal member

2a pedal end

2b biasing end

3 fulcrum

4 housing

5 abutment portion

6 foot plate

7 slide member

8 spring member

9 first end

10 second end

11 pressure-exerting spring

12 supporting portion

13 contact area

14 fastener

I claim:

1. A pedal assembly for use in a motor vehicle, the pedal assembly comprising:
a pedal member partially mounted in a housing and configured to rotate about a fulcrum;
at least one pressure-exerting spring biasing the pedal member to an initial position, the pedal member being pivotable about the fulcrum against a force of the at least one pressure-exerting spring; and
a spring member disposed inside the housing, one end of the spring member being fixedly fastened to the housing and an opposite end of the spring member being moveably mounted to the housing, the pedal member having a slide member which when the pedal member is actuated slides on and along one side of the spring member and exerts pressure on the one side of the spring member.

2. The pedal assembly of claim 1, wherein the spring member is a leaf spring.

3. The pedal assembly of claim 2, wherein the leaf spring is comprised of a metal material.

4. The pedal assembly of claim 1, wherein when the slide member moves as the pedal member is pivoted about the fulcrum, the spring member exerts a counter-force against the slide member and undergoes resilient deformation at the same time.

5. The pedal assembly of claim 4, wherein the counter-force generated by the spring member and directed against the slide member under the relative movement between the slide member and the spring member contributes to an automatic pivoting of the pedal member towards the initial position.

6. The pedal assembly of claim 1, wherein the opposite end of the spring member abuts a supporting portion of the housing.

7. The pedal assembly of claim 1, wherein the slide member is comprised of a plastic material.

8. The pedal assembly of claim 1, wherein the pedal member includes an abutment portion configured to engage an area of housing in a final position.

9. The pedal assembly of claim 1, wherein the at least one pressure-exerting spring includes a compression spring having one end supported on the pedal member and an opposite end supported on the housing.

10. The pedal assembly of claim 1, wherein the spring member is disposed on a side opposite a foot plate of the pedal member relative to the fulcrum.

11. The pedal assembly of claim 1, wherein the at least one pressure-exerting spring is disposed on the side opposite foot plate of pedal member relative to fulcrum.

12. The pedal assembly of claim 1, wherein as the pedal member rotates from the initial position about the fulcrum and returns towards the initial position by rotating about the fulcrum, the pressure-exerting spring and the spring member co-operate by generating different force gradients.

13. The pedal assembly of claim 1, wherein the spring member biases the pedal member toward the initial position and wherein a rate of change in biasing force during movement of the pedal member is greater proximate the initial position and a final position than a central position between the initial and final positions.

14. The pedal assembly of claim 1, wherein the spring member biases the pedal member toward the initial position and wherein a biasing force during a forward stroke of the pedal member is greater than a biasing force during a return stroke of the pedal member.

15. A pedal assembly comprising:
a pedal member configured to rotate about a fulcrum from an initial position to a first position, from the first position to a second position and from the second position to a final position, the pedal moving a first distance between the initial position and the first position, a second distance between the first position and the second position and a third distance between the second position and the third position; and
a purely mechanical biasing system coupled to the pedal member and configured to bias the pedal member from the final position to the second position, from the second position to the first position and from the first position to the initial position,
wherein a first increase in biasing force between the initial position and the first position over the first distance and a third increase in biasing force between the second position and the final position over the third distance are each greater than a second increase in biasing force between the first position and the final position over the second distance.

16. The pedal assembly of claim 15 further comprising:
a housing, and
wherein the pedal member has a biasing end disposed within the housing and a pedal end disposed outside of the housing, the pedal member configured to rotate about the fulcrum between the biasing end and the pedal end, the biasing assembly being coupled to the biasing end.

17. The pedal assembly of claim 16, wherein the biasing system includes a spring member, one end of the spring member being fixedly fastened to the housing and an opposite end of the spring member being moveably mounted to the housing, the pedal member having a slide member which when the pedal member is actuated slides on and along one side of the spring member and exerts pressure on the one side of the spring member.

18. The pedal assembly of claim 15, wherein the biasing system includes at least one compression spring.

19. The pedal assembly of claim 15, wherein the biasing system includes a leaf spring.

20. The pedal assembly of claim 15, wherein a biasing force during a forward stroke of the pedal member is greater than a biasing force during a return stroke of the pedal member.

21. A pedal assembly comprising:
a pedal member configured to rotate about a fulcrum between an initial position to a final position; and
a purely mechanical biasing system coupled to the pedal member and configured to bias the pedal member from the final position to the initial position, a biasing force during a forward stroke of the pedal member from the initial position to the final position being greater than a biasing force during the return stroke of the pedal member from the final position to the initial position.

22. The pedal assembly of claim 21, wherein the biasing system includes a leaf spring.
